(19) United States
(12) Patent Application Publication
(10) Pub. No.: US 2023/0236797 A1
(43) Pub. Date: Jul. 27, 2023

(54) BIT-SERIAL COMPUTING DEVICE AND TEST METHOD FOR EVALUATING THE SAME

(71) Applicant: National Tsing Hua University, Hsinchu City (TW)

(72) Inventors: Yu-Chih TSAI, Hsinchu City (TW); Wen-Chien TING, Hsinchu City (TW); Ren-Shuo LIU, Hsinchu City (TW)

(73) Assignee: National Tsing Hua University, Hsinchu City (TW)

(21) Appl. No.: 18/155,970

(22) Filed: Jan. 18, 2023

Related U.S. Application Data
(60) Provisional application No. 63/302,134, filed on Jan. 24, 2022.

(51) Int. Cl. G06F 7/544; G06F 7/523

(52) U.S. Cl. CPC G06F 7/5443; G06F 7/523

(57) ABSTRACT

A bit-serial computing device includes a computing circuit and a scaler. The computing circuit includes multiple MAC slices, and receives a multiplier vector and a multiplicand vector that contains multiple multiplicand inputs. Each multiplicand input contains multiple multiplicand segments that have different significances. The significances respectively correspond to the MAC slices. Correspondence between the significances and the MAC slices is variable. Each MAC slice calculates an inner product of the multiplier vector and a vector that is constituted by the multiplicand segments of the multiplicand inputs having the significance corresponding to the MAC slice. With respect to each MAC slice, the scaler multiplies the inner product that is calculated by the MAC slice by a weighting ratio that represents the significance corresponding to the MAC slice, so as to obtain a scaled inner product that corresponds to the MAC slice.

### CROSS-REFERENCE TO RELATED APPLICATION

This application claims the benefit of U.S. Provisional Patent Application No. 63/302134, filed on Jan. 24, 2022, which is incorporated by reference herein in its entirety.

### FIELD

The disclosure relates to computing technology, and more particularly to a bit-serial computing device and a test method for evaluating the same.

### BACKGROUND

Bit-serial computing can be used in neural networks. For bit-serial computing, it is important to enhance output accuracy.

### SUMMARY

Therefore, an object of the disclosure is to provide a bit-serial computing device and a method for evaluating the same. The computing device can have improved output accuracy.

According to an aspect of the disclosure, the bit-serial computing device includes a computing circuit and a scaler. The computing circuit receives a feed-in multiplier vector and a feed-in multiplicand vector, and includes a number (N) of multiply-and-accumulate (MAC) slices, where N≥2. The feed-in multiplier vector contains a number (M) of multiplier inputs, where M≥2. The feed-in multiplicand vector contains a number (M) of multiplicand inputs, each of which contains a number (N) of multiplicand segments that have different significances. The significances respectively correspond to the MAC slices. Correspondence between the significances and the MAC slices is variable. Each of the MAC slices calculates an inner product of the feed-in multiplier vector and a vector that is constituted by the multiplicand segments of the multiplicand inputs of the feed-in multiplicand vector having the significance corresponding to the MAC slice. The scaler is coupled to the MAC slices to receive the inner products that are respectively calculated by the MAC slices, and further receives a control signal. With respect to each of the MAC slices, the scaler multiplies the inner product that is calculated by the MAC slice by a weighting ratio that represents the significance corresponding to the MAC slice based on the control signal, so as to obtain a scaled inner product that corresponds to the MAC slice.

According to another aspect of the disclosure, the test method is for evaluating the bit-serial computing device described above, and includes steps of: (A) generating at least one first test multiplier vector and at least one second test multiplier vector, where a first linear function of the at least one first test multiplier vector is equal to a second linear function of the at least one second test multiplier vector; (B) sequentially providing the first and second test multiplier vectors to the computing circuit as the feed-in multiplier vector, so that each of the MAC slices sequentially obtains at least one first inner product that corresponds to the at least one first test multiplier vector and at least one second inner product that corresponds to the at least one second test multiplier vector as the inner product calculated thereby; (C) with respect to each of the MAC slices, calculating an absolute deviation that corresponds to the MAC slice, and that equals an absolute value of the first linear function of the at least one first inner product obtained by the MAC slice minus the second linear function of the at least one second inner product obtained by the MAC slice; (D) repeating step (B) and step (C), and with respect to each of the MAC slices, accumulating the absolute deviation that corresponds to the MAC slice, so as to obtain an accumulated deviation that corresponds to the MAC slice; and (E) generating an evaluation output based on the accumulated deviations that respectively correspond to the MAC slices, where the evaluation output indicates a relative relationship of accuracies of the MAC slices, and the accuracy of one of the MAC slices is determined to be higher than the accuracy of another one of the MAC slices when the accumulated deviation that corresponds to said one of the MAC slices is smaller than the accumulated deviation that corresponds to said another one of the MAC slices.

According to yet another aspect of the disclosure, the bit-serial computing device includes a computing circuit, a test pattern generator and an evaluator. The computing circuit includes a MAC slice that calculates an inner product of a feed-in multiplier vector and another vector. The test pattern generator is coupled to the computing circuit, and generates at least one first test multiplier vector and at least one second test multiplier vector, where a first linear function of the at least one first test multiplier vector is equal to a second linear function of the at least one second test multiplier vector. The test pattern generator sequentially provides the first and second test multiplier vectors to the computing circuit as the feed-in multiplier vector, so that the MAC slice sequentially obtains at least one first inner product that corresponds to the at least one first test multiplier vector and at least one second inner product that corresponds to the at least one second test multiplier vector as the inner product calculated by the MAC slice. The evaluator is coupled to the MAC slice to receive the at least one first inner product and the at least one second inner product, calculates an absolute deviation that equals an absolute value of the first linear function of the at least one first inner product minus the second linear function of the at least one second inner product; and increases an accumulated deviation by the absolute deviation.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating an embodiment of a bit-serial computing device according to the disclosure.

FIG. 2 is a flow chart illustrating a test method for evaluating the embodiment.

FIG. 3 is a block diagram illustrating a first exemplary implementation of a computing circuit of the embodiment.

FIG. 4 is a block diagram illustrating a second exemplary implementation of the computing circuit which is controlled in a first way.

FIG. 5 is a circuit block diagram illustrating an example of an analog-to-digital converter of the second exemplary implementation of the computing circuit.

FIG. 6 is block diagram illustrating a second way to control the second exemplary implementation of the computing circuit.

FIG. 7 is a block diagram illustrating a first exemplary implementation of a scaler of the embodiment.

FIG. 8 is a block diagram illustrating a second exemplary implementation of the scaler.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

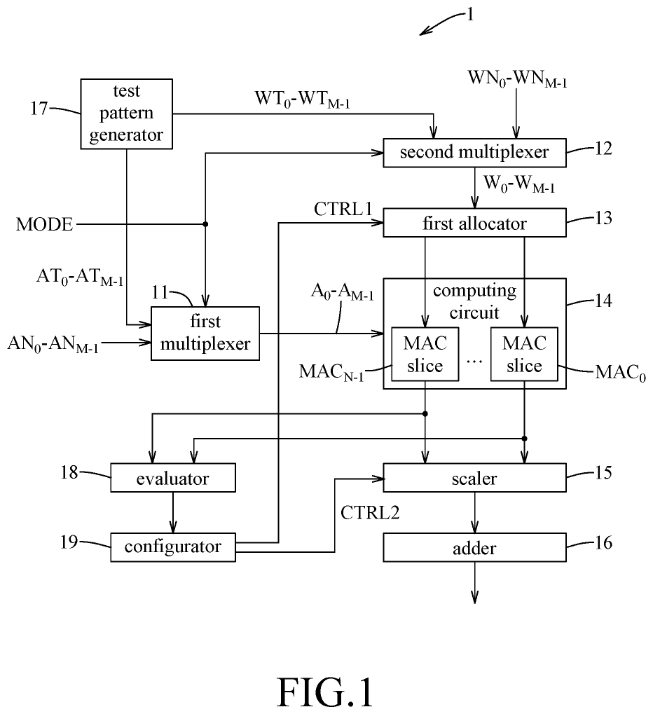

Referring to FIG. 1, an embodiment of a bit-serial computing device 1 according to the disclosure is operable in a normal mode and a test mode, and includes a first multiplexer 11, a second multiplexer 12, a first allocator 13, a computing circuit 14, a scaler 15, an adder 16, a test pattern generator 17, an evaluator 18 and a configurator 19.

The first multiplexer 11 receives a normal multiplier vector, a test multiplier vector and a mode signal (MODE). The normal multiplier vector contains a number (M) of multiplier inputs (AN₀-AN_{M-1}), where M≥2. The test multiplier vector contains a number (M) of multiplier inputs (AT₀-AT_{M-1}). Each of the multiplier inputs (AN₀-AN_{M-1}, AT₀-AT_{M-1}) of the normal and test multiplier vectors is at least one bit wide. The first multiplexer 11 outputs the normal multiplier vector as a feed-in multiplier vector when the mode signal (MODE) indicates that the bit-serial computing device 1 of this embodiment operates in the normal mode, and outputs the test multiplier vector as the feed-in multiplier vector when the mode signal (MODE) indicates that the bit-serial computing device 1 of this embodiment operates in the test mode. Therefore, the feed-in multiplier vector contains a number (M) of multiplier inputs (A₀-A_{M-1}); and the multiplier input (Aₘ) of the feed-in multiplier vector is equal to the multiplier input (ANₘ) of the normal multiplier vector when the mode signal (MODE) indicates that the bit-serial computing device 1 of this embodiment operates in the normal mode, and is equal to the multiplier input (ATₘ) of the test multiplier vector when the mode signal (MODE) indicates that the bit-serial computing device 1 of this embodiment operates in the test mode, where 0≤m≤M−1. It should be noted that, when the bit-serial computing device 1 of this embodiment is used in a neural network, the normal multiplier vector is one of an activation vector and a weight vector.

The second multiplexer 12 receives a normal multiplicand vector, a test multiplicand vector and the mode signal (MODE). The normal multiplicand vector contains a number (M) of multiplicand inputs (WN₀—WN_{M-1}). The test multiplicand vector contains a number (M) of multiplicand inputs (WT₀-WT_{M-1}). Each of the multiplicand inputs (WN₀—WN_{M-1}, WT₀-WT_{M-1}) of the normal and test multiplicand vectors is at least N bits wide, where N≥2. The second multiplexer 11 outputs the normal multiplicand vector as a feed-in multiplicand vector when the mode signal (MODE) indicates that the bit-serial computing device 1 of this embodiment operates in the normal mode, and outputs the test multiplicand vector as the feed-in multiplicand vector when the mode signal (MODE) indicates that the bit-serial computing device 1 of this embodiment operates in the test mode. Therefore, the feed-in multiplicand vector includes a number (M) of multiplicand inputs (W₀-W_{M-1}); and the multiplicand input (Wₘ) of the feed-in multiplicand vector is equal to the multiplicand input (WNₘ) of the normal multiplicand vector when the mode signal (MODE) indicates that the bit-serial computing device 1 of this embodiment operates in the normal mode, and is equal to the multiplicand input (WTₘ) of the test multiplicand vector when the mode signal (MODE) indicates that the bit-serial computing device 1 of this embodiment operates in the test mode, where Om_{M-1}. In addition, each of the multiplicand inputs (W₀-W_{M-1}) of the feed-in multiplicand vector contains a number (N) of multiplicand segments (W_{0,0}−W_{0,N-1}, . . . , or W_{M-1,0}−W_{M-1,N-1}), each of which is at least one bit wide, and which have different significances. The multiplicand segments (W_{0,0}−W_{M-1,0}, . . . , or W_{0,N-1}—W_{M-1,N-1}) of the multiplicand inputs (W₀-W_{M-1}) of the feed-in multiplicand vector have the same significance. The significance of the multiplicand segments (W_{0,n}—W_{M-1,n}) of the multiplicand inputs (W₀-W_{M-1}) of the feed-in multiplicand vector is greater than the significance of the multiplicand segments (W_{0,n-1}—W_{M-1,n-1}) of the multiplicand inputs (W₀-W_{M-1}) of the feed-in multiplicand vector, where 1≤n≤N−1. It should be noted that, when the bit-serial computing device 1 of this embodiment is used in the neural network, the normal multiplicand vector is the other one of the activation vector and the weight vector.

The computing circuit 14 is coupled to the first multiplexer 11 to receive the feed-in multiplier vector, and at least includes a number (N) of multiply-and-accumulate (MAC) slices (MAC₀−MAC_{N-1}).

The first allocator 13 is coupled to the second multiplexer 12 to receive the feed-in multiplicand vector, is further coupled to the MAC slices (MAC₀-MAC_{N-1}), and further receives a control signal (CTRL1). With respect to each of the significances, the first allocator 13 outputs the multiplicand segments (W_{0,0}—W_{M-1,0}, . . . , or W_{0,N-1}—W_{M-1,N-1}) of the multiplicand inputs (W₀-W_{M-1}) of the feed-in multiplicand vector that have the significance for receipt by a corresponding one of the MAC slices (MAC₀−MAC_{N—1}) based on the control signal (CTRL1). The significances respectively correspond to the MAC slices (MAC0-MAC_{N—1}). Correspondence between the significances and the MAC slices (MAC₀−MAC_{N—1}) is variable, and is indicated by the control signal (CTRL1). The first allocator 13 may be implemented using a number (N²) of switches that are arranged in an N×N crossbar configuration.

Each of the MAC slices (MAC₀−MAC_{N—1}) calculates an inner product of the feed-in multiplier vector and a vector that is constituted by the multiplicand segments (W_{0,0}—W_{M-1,0}, . . . , or W_{0,N-1}—W_{M-1,N-1}) of the multiplicand inputs (W₀-W_{M-1}) of the feed-in multiplicand vector received thereby, which is equal to Σ₀^{M-1}Aₘ·W_{m,n}, where 0≤n≤N−1.

The scaler 15 is coupled to the MAC slices (MAC₀−MAC_{N—1}) to receive the inner products that are respectively calculated by the MAC slices (MAC₀−MAC_{N—1}), and further receives a control signal (CTRL2). With respect to each of the MAC slices (MAC₀−MAC_{N—1}), the scaler 15 multiplies the inner product that is calculated by the MAC slice (MAC₀/ . . . /MAC_{N—1}) by a weighting ratio (R₀/ . . . /R_{N-1}) that represents the significance corresponding to the MAC slice (MAC₀/ . . . /MAC_{N—1}) based on the control signal (CTRL2), so as to obtain a scaled to inner product that corresponds to the MAC slice (MAC₀/ . . . /MAC_{N—1}) and that is equal to Rₙ·Σ₀^{M-1}Aₘ·W_{m,n}, where 0≤n·N−1. In an example where each of the multiplicand segments (W_{0,0}—W_{0,N-1}, . . . , W_{M-1,0}—W_{M-1,N-1}) of the multiplicand inputs (W₀-W_{M-1}) of the feed-in multiplicand vector is one bit wide, the weighting ratio (Rₙ) may be 2ⁿ. In another example where each of the multiplicand segments (W_{0,0}—W_{0,N-1}, . . . , W_{M-1,0}—W_{M-1,N-1}) of the multiplicand inputs (W₀-W_{M-1}) of the feed-in multiplicand vector is two bits wide, the weighting ratio (Rₙ) may be 4ⁿ. In yet another example where each of the multiplicand segments (W_{0,0}—W_{0,N-1}, . . . , W_{M-1,0}—W_{M-1,N-1}) of the multiplicand inputs (W₀-W_{M-1}) of the feed-in multiplicand vector is three bits wide, the weighting ratio (Rₙ) may be 8ⁿ. However, the disclosure is not limited to these examples.

The adder 16 is coupled to the scaler 15 to receive the scaled inner products that respectively correspond to the MAC slices (MAC₀−MAC_{N—1}), and adds the scaled inner products together to obtain an inner product of the feed-in multiplier vector and the feed-in multiplicand vector, which is equal to Σ₀^{M-1}Aₘ·(Σ₀^{N-1}Rₙ·W_{m,n})

The test pattern generator 17 is coupled to the first and second multiplexers 11, 12, and generates the test multiplier vector to be received by the first multiplexer 11 and the test multiplicand vector to be received by the second multiplexer 12.

The evaluator 18 is coupled to the MAC slices (MAC₀−MAC_{N—1}) to receive the inner products that are respectively calculated by the MAC slices (MAC₀−MAC_{N-1}), and generates an evaluation output that indicates a relative relationship of accuracies of the MAC slices (MAC₀−MAC_{N—1}) based on the inner products.

The configurator 19 is coupled to the evaluator 18 to receive the evaluation output, is further coupled to the first allocator 13 and the scaler 15, and generates the control signal (CTRL1) to be received by the first allocator 13 and the control signal (CTRL2) to be received by the scaler 15 based on the evaluation output.

In this embodiment, initially, the configurator 19 generates the control signal (CTRL1) corresponding to that of the first allocator 13 which outputs the multiplicand segments (W_{0,n}—W_{M-1,n}) of the multiplicand inputs (W₀-W_{M-1}) of the feed-in multiplicand vector to the MAC slice (MACₙ), and generates the control signal (CTRL2) corresponding to that of the scaler 15 which multiplies the inner product calculated by the MAC slice (MACₙ) by the weighting ratio (Rₙ), where 0≤n≤N−1. Then, after the evaluator 18 generates the evaluation output, level one reordering is performed, so that output accuracy of the bit-serial computing device 1 can be enhanced. That is, the configurator 19 generates the control signal (CTRL1) corresponding to that of the first allocator 13 which outputs the multiplicand segments (W_{0,N-1}—W_{M-1,N-1}) of the multiplicand inputs (W₀-W_{M-1}) of the feed-in multiplicand vector having a largest one of the significances to the one of the MAC slices (MAC₀−MAC_{N—1}) having the highest accuracy among all of the MAC slices (MAC₀−MAC_{N—1}), and generates the control signal (CTRL2) corresponding to that of the scaler 15 which multiplies the inner product calculated by said one of the MAC slices (MAC₀−MAC_{N—1}) by the weighting ratio (R_{N-1}) representing the largest one of the significances. In an example where M=16, where N=8, and where the evaluation output indicates that the MAC slice (MAC₁) has the highest accuracy among all of the MAC slices (MAC₀−MAC₇), the control signal (CTRL1) may correspond to that of the first allocator 13 which outputs the multiplicand segments (W_{0,7}—W_{15,7}) of the multiplicand inputs (W₀-W₁₅) of the feed-in multiplicand vector to the MAC slice (MAC₁), outputs the multiplicand segments (W_{0,1}—W_{15,1}) of the multiplicand inputs (W₀-W₁₅) of the feed-in multiplicand vector to the MAC slice (MAC₇), and outputs the multiplicand segments (W_{0,n}—W_{15,n}) of the multiplicand inputs (W₀-W₁₅) of the feed-in multiplicand vector to the MAC slice (MACₙ), where n=0, 2, 3, 4, 5 or 6.

In another embodiment, after the evaluator 18 generates the evaluation output, level two reordering is performed, so that the output accuracy of the bit-serial computing device 1 can be further enhanced as compared to the previous embodiment where the level one reordering is performed. That is, the configurator 19 generates the control signal (CTRL1) further corresponding to that of the first allocator 13 which outputs the multiplicand segments (W_{0,N-2}—W_{M-1,N-2}) of the multiplicand inputs (W₀-W_{M-1}) of the feed-in multiplicand vector having a second largest one of the significances to another one of the MAC slices (MAC₀-MAC_{N-1}) having the second highest accuracy among all of the MAC slices (MAC₀-MAC_{N-1}), and generates the control signal (CTRL2) further corresponding to that of the scaler 15 which multiplies the inner product calculated by said another one of the MAC slices (MAC₀−MAC_{N—1}) by the weighting ratio (R_{N-2}) representing the second largest one of the significances. In an example where M=16, where N=8, and where the evaluation output indicates that the MAC slice (MAC₁) has the highest accuracy among all of the MAC slices (MAC₀−MAC₇) and that the MAC slice (MAC₃) has the second highest accuracy among all of the MAC slices (MAC₀−MAC₇), the control signal (CTRL1) may correspond to that of the first allocator 13 which outputs the multiplicand segments (W_{0,7}—W_{15,7}) of the multiplicand inputs (W₀-W₁₅) of the feed-in multiplicand vector to the MAC slice (MAC₁), outputs the multiplicand segments (W_{0,6}—W_{15,6}) of the multiplicand inputs (W₀-W₁₅) of the feed-in multiplicand vector to the MAC slice (MAC₃), outputs the multiplicand segments (W_{0,3}—W_{15,3}) of the multiplicand inputs (W₀-W₁₅) of the feed-in multiplicand vector to the MAC slice (MAC₆), outputs the multiplicand segments (W_{0,1}—W_{15,1}) of the multiplicand inputs (W₀-W₁₅) of the feed-in multiplicand vector to the MAC slice (MAC₇), and outputs the multiplicand segments (W_{0,n}—W_{15,n}) of the multiplicand inputs (W₀-W₁₅) of the feed-in multiplicand vector to the MAC slice (MACₙ), where n=0, 2, 4 or 5.

In yet another embodiment, after the evaluator 18 generates the evaluation output, level three reordering is performed, so that the output accuracy of the bit-serial computing device 1 can be further enhanced as compared to the previous embodiment where the level two reordering is performed. That is, the configurator 19 generates the control signal (CTRL1) further corresponding to that of the first allocator 13 which outputs the multiplicand segments (W_{0,N-3}—W_{M-1,N-3}) of the multiplicand inputs (W₀-W_{M-1}) of the feed-in multiplicand vector having a third largest one of the significances to yet another one of the MAC slices (MAC₀−MAC_{N-1}) having the third highest accuracy among all of the MAC slices (MAC₀−MAC_{N—1}), and generates the control signal (CTRL2) further corresponding to that of the scaler 15 which multiplies the inner product calculated by said yet another one of the MAC slices (MAC₀−MAC_{N—1}) by the weighting ratio (R_{N-3}) representing the third largest one of the significances. In an example where M=16, where N=8, and where the evaluation output indicates that the MAC slice (MAC₁) has the highest accuracy among all of the MAC slices (MAC₀−MAC₇), that the MAC slice (MAC₃) has the second highest accuracy among all of the MAC slices (MAC₀−MAC₇), and that the MAC slice (MAC₄) has the third highest accuracy among all of the MAC slices (MAC₀−MAC₇), the control signal (CTRL1) may correspond to that of the first allocator 13 which outputs the multiplicand segments (W_{0,7}—W_{15,7}) of the multiplicand inputs (W₀-W₁₅) of the feed-in multiplicand vector to the MAC slice (MAC₁), outputs the multiplicand segments (W_{0,6}—W_{15,6}) of the multiplicand inputs (W₀-W₁₅) of the feed-in multiplicand vector to the MAC slice (MAC₃), outputs the multiplicand segments (W_{0,5}—W_{15,5}) of the multiplicand inputs (W₀-W₁₅) of the feed-in multiplicand vector to the MAC slice (MAC₄), outputs the multiplicand segments (W_{0,4}—W_{15,4}) of the multiplicand inputs (W₀-W₁₅) of the feed-in multiplicand vector to the MAC slice (MAC₅), outputs the multiplicand segments (W_{0,3}—W_{15,3}) of the multiplicand inputs (W₀-W₁₅) of the feed-in multiplicand vector to the MAC slice (MAC₆), outputs the multiplicand segments (W_{0,1}—W_{15,1}) of the multiplicand inputs (W₀-W₁₅) of the feed-in multiplicand vector to the MAC slice (MAC₇), and outputs the multiplicand segments (W_{0,n}—W_{15,n}) of the multiplicand inputs (W₀-W₁₅) of the feed-in multiplicand vector to the MAC slice (MACₙ), where n=0 or 2.

It should be noted that, in other embodiments, even higher level reordering may be performed, so that the output accuracy of the bit-serial computing device 1 can be further enhanced as compared to the embodiment where the level three reordering is performed.

In still another embodiment, after the evaluator 18 generates the evaluation output, a predetermined reordering is performed, so that the output accuracy of the bit-serial computing device 1 can be enhanced. That is, the configurator 19 generates the control signal (CTRL1) corresponding to that of the first allocator 13 which outputs the multiplicand segments (W_{0,0}−W_{M-1,0}) of the multiplicand inputs (W₀−W_{M-1}) of the feed-in multiplicand vector having a smallest one of the significances to one of the MAC slices (MAC₀−MAC_{N—1}) having the lowest accuracy among all of the MAC slices (MAC₀−MAC_{N—1}), and generates the control signal (CTRL2) corresponding to that of the scaler 15 which multiplies the inner product calculated by said one of the MAC slices (MAC₀−MAC_{N—1}) by the weighting ratio (R₀) representing the smallest one of the significances. In an example where M=16, where N=8, and where the evaluation output indicates that the MAC slice (MAC₂) has the lowest accuracy among all of the MAC slices (MAC₀−MAC₇), the control signal (CTRL1) may correspond to that of the first allocator 13 which outputs the multiplicand segments (W_{0,0}−W_{15,0}) of the multiplicand inputs (W₀−W₁₅) of the feed-in multiplicand vector to the MAC slice (MAC₂), outputs the multiplicand segments (W_{0,2}−W_{15,2}) of the multiplicand inputs (W₀−W₁₅) of the feed-in multiplicand vector to the MAC slice (MAC₀), and outputs the multiplicand segments (W_{0,n}−W_{15,n}) of the multiplicand inputs (W₀−W₁₅) of the feed-in multiplicand vector to the MAC slice (MACₙ), where n=1, 3, 4, 5, 6 or 7.

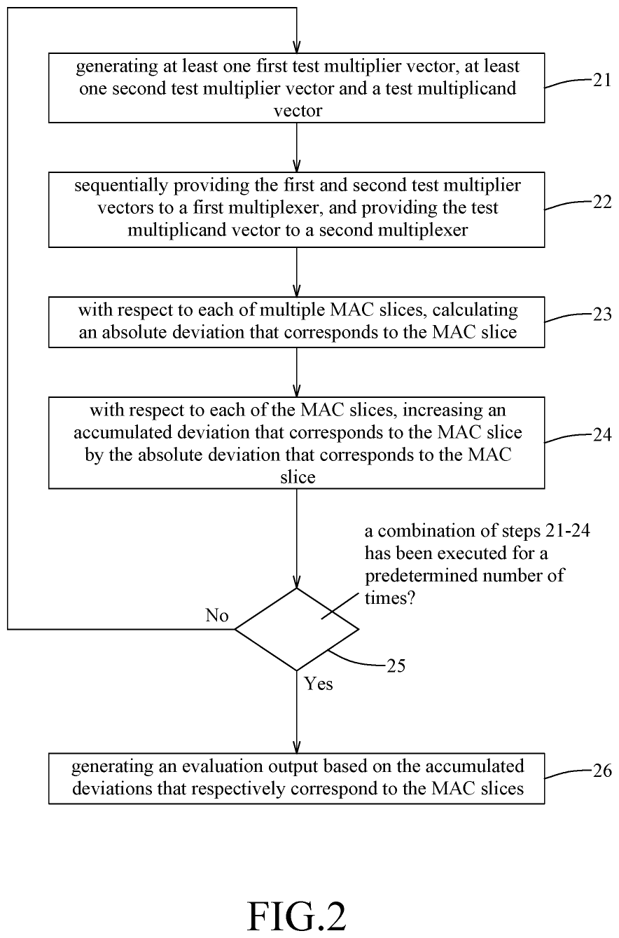

FIG. 2 illustrates a test method that is performed by the bit-serial computing device 1 of this embodiment when operating in the test mode for evaluating the accuracies of the MAC slices (MAC₀−MAC_{N—1}). Referring to FIGS. 1 and 2, in this embodiment, the test method includes the following steps 21-26.

In step 21, the test pattern generator 17 generates at least one first test multiplier vector, at least one second test multiplier vector and a test multiplicand vector, where a first linear function of the at least one first test multiplier vector (e.g., a₁·x₁+a₂·x₂+ . . . +a_{I}·x_{I}, where a₁, a₂, . . . , and a_{I} are coefficients, x₁, x₂, . . . , and x_{I} are the first test multiplier vectors, and I≥1) is equal to a second linear function of the at least one second test multiplier vector (e.g., b₁·y₁+b₂·y₂+ . . . +b_{J}·y_{J}, where b₁, b₂, . . . , and b_{J} are coefficients, y₁, y₂, . . . , and y_{J} are the second test multiplier vectors, and J≤1). When a plurality of first test multiplier vectors are generated, the first test multiplier vectors may be different from each other, or at least two of the first multiplier vectors may be identical. Similarly, when a plurality of second test multiplier vectors are generated, the second test multiplier vectors may be different from each other, or at least two of the second multiplier vectors may be identical. In a first example, a first test multiplier vector (x₁) and two second test multiplier vectors (y₁, y₂) are generated, and x₁=y₁+y₂. In a second example, two first test multiplier vectors (x₁, x₂) and a second test multiplier vector (y₁) are generated, and 2·x₁+x₂=y₁. In a third example, three test multiplier vectors (x₁, x₂, x₃) and a second test multiplier vector (y₁) are generated, x₁=x₃, and x₁+x₂+x₃=y₁. However, the disclosure is not limited to these examples.

In step 22, the test pattern generator 17 sequentially provides the first and second test multiplier vectors to the first multiplexer 11, and provides the test multiplicand vector to the second multiplexer 12. As a consequence, the first and second test multiplier vectors sequentially pass through the first multiplexer 11 to serve as the feed-in multiplier vector that is to be received by the computing circuit 14, the test multiplicand vector passes through the second multiplexer 12 to serve as the feed-in multiplicand vector that is to be received by the first allocator 13, and each of the MAC slices (MAC₀−MAC_{N—1}) sequentially obtains at least one first inner product that corresponds to the at least one first test multiplier vector and at least one second inner product that corresponds to the at least one second test multiplier vector as the inner product calculated thereby. In the aforesaid first example, the MAC slice (MACₙ) sequentially obtains a first inner product (<x₁,wₙ>) and two second inner products (<y₁,wₙ>, <y₂,wₙ>), where wₙ denotes the vector that is constituted by the multiplicand segments (W_{0,n}—W_{M-1,n}) of the multiplicand inputs (W₀-W_{M-1}) of the feed-in multiplicand vector, and 0≤n≤N−1. In the aforesaid second example, the MAC slice (MACₙ) sequentially obtains two first inner products (<x₁,wₙ>, <x₂,wₙ>) and a second inner product (<y₁,wₙ>). In the aforesaid third example, the MAC slice (MACₙ) sequentially obtains three first inner products (<x₁,wₙ>, <x₂,wₙ>, <x₃,wₙ>) and a second inner product (<y₁,wₙ>).

In step 23, with respect to each of the MAC slices (MAC₀−MAC_{N—1}), the evaluator 18 calculates an absolute deviation that corresponds to the MAC slice (MAC₀/ . . . /MAC_{N—1}), and that equals an absolute value of the first linear function of the at least one first inner product obtained by the MAC slice (MAC₀/ . . . /MAC_{N—1}) minus the second linear function of the at least one second inner product obtained by the MAC slice (MAC₀/ . . . /MAC_{N—1}). In the aforesaid first example, the absolute deviation corresponding to the MAC slice (MACₙ) is equal to |<x₁,wₙ>−(<y₁,wₙ>+<y₂,wₙ>)|. In the aforesaid second example, the absolute deviation corresponding to the MAC slice (MACₙ) is equal to |(2·<x₁,wₙ>+<x₂,wₙ>)−<y₁,wₙ>|. In the aforesaid third example, the absolute deviation corresponding to the MAC slice (MACₙ) is equal to |(<x₁,wₙ>+<x₂,wₙ>+<x₃,wₙ>)−<y₁,wₙ>|.

In step 24, with respect to each of the MAC slices (MAC₀−MAC_{N—1}), the evaluator 18 increases an accumulated deviation corresponding to the MAC slice (MAC₀/ . . . /MAC_{N—1}) by the absolute deviation corresponding to the MAC slice (MAC₀/ . . . /MAC_{N—1}). It should be noted that the accumulated deviation corresponding to the MAC slice (MAC₀/ . . . /MAC_{N—1}) is set to be zero before the test method is to be performed.

In step 25, the evaluator 18 determines whether a combination of steps 21-24 has been executed for a predetermined number of times (e.g., one-hundred times or more). If affirmative, the flow proceeds to step 26. Otherwise, the flow goes back to step 21.

By virtue of steps 24, 25, steps 21-23 are repeated, and with respect to each of the MAC slices (MAC₀−MAC_{N—1}), the absolute deviation corresponding to the MAC slice (MAC₀/ . . . /MAC_{N—1}) is accumulated to obtain the accumulated deviation corresponding to the MAC slice (MAC₀/ . . . /MAC_{N—1}).

In step 26, the evaluator 18 generates the evaluation output based on the accumulated deviations that respectively correspond to the MAC slices (MAC₀−MAC_{N-1}), where the accuracy of one of the MAC slices (MAC₀−MAC_{N-1}) is determined to be higher than the accuracy of another one of the MAC slices (MAC₀-MAC_{N-1}) when the accumulated deviation that corresponds to said one of the MAC slices (MAC₀−MAC_{N-1}) is smaller than the accumulated deviation that corresponds to said another one of the MAC slices (MAC₀−MAC_{N-1}).

It should be noted that, in a first modification of this embodiment, in step 26, the evaluator 18 may calculate, with respect to each of the MAC slices (MAC₀−MAC_{N-1}), an average deviation corresponding to the MAC slice (MAC₀/ . . . /MAC_{N—1}) based on the accumulated deviation corresponding to the MAC slice (MAC₀/ . . . /MAC_{N—1}), and may generate the evaluation output based on the average deviations that respectively correspond to the MAC slices (MAC₀−MAC_{N-1}). In a second modification of this embodiment, the generation of the test multiplicand vector in step 21 and the providing of the test multiplicand vector to the second multiplexer 12 in step 22 may be omitted, and the multiplicand vector that has been stored in the MAC slices (MAC₀−MAC_{N—1}) may be used by the MAC slices (MAC₀−MAC_{N—1}) to calculate the inner products. In a third modification of this embodiment, step 21 may be executed once, instead of repeatedly. That is, if the determination in step 25 is negative, the flow goes back to step 22, instead of step 21.

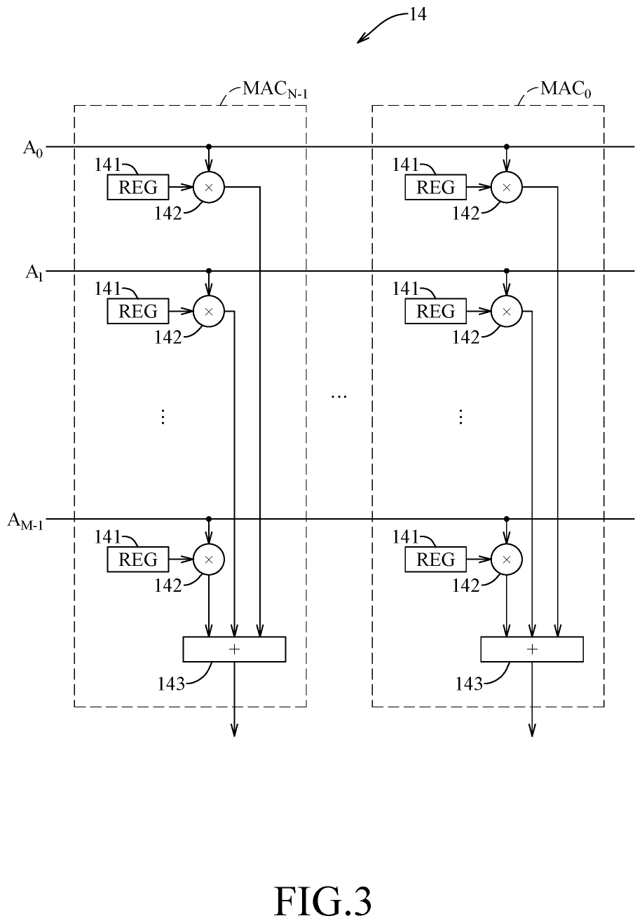

FIG. 3 illustrates a first exemplary implementation of the computing circuit 14. Referring to FIGS. 1 and 3, in the first exemplary implementation, the computing circuit 14 is implemented using digital circuits, and each of the MAC slices (MAC₀−MAC_{N—1}) includes a number (M) of registers (REGs) 141, a number (M) of multipliers 142 and a summator 143. With respect to each of the MAC slices (MAC₀−MAC_{N—1}), the registers 141 respectively store the multiplicand segments (W_{0,0}—W_{M-1,0}, . . . , or W_{0,N-1}—W_{M-1,N-1}) of the multiplicand inputs (W₀-W_{M-1}) of the feed-in multiplicand vector that are received by the MAC slice (MAC₀/ . . . /MAC_{N—1}). Each of the multipliers 142 is coupled to a respective one of the registers 141 to receive the multiplicand segment (W_{0,n}/ . . . /W_{M-1,n}) stored in the respective one of the registers 141, further receives a respective one of the multiplier inputs (A₀-A_{M-1}) of the feed-in multiplier vector, and calculates a product of the multiplicand segment (W_{0,n}/ . . . /W_{M-1,n}) thus received and the multiplier input (A₀/ . . . /A_{M-1}) thus received, which is equal to Aₘ×W_{m,n}, where 0≤m≤M−1 and 0≤n≤N−1. The summator 143 is coupled to the multipliers 142 to receive the products that are respectively calculated by the multipliers 142, is further coupled to the scaler 15 and the evaluator 18, and calculates a sum of the products which is used to obtain the inner product that is to be calculated by the MAC slice (MAC₀/ . . . /MAC_{N-1}) and that is to be received by the scaler 15 and the evaluator 18.

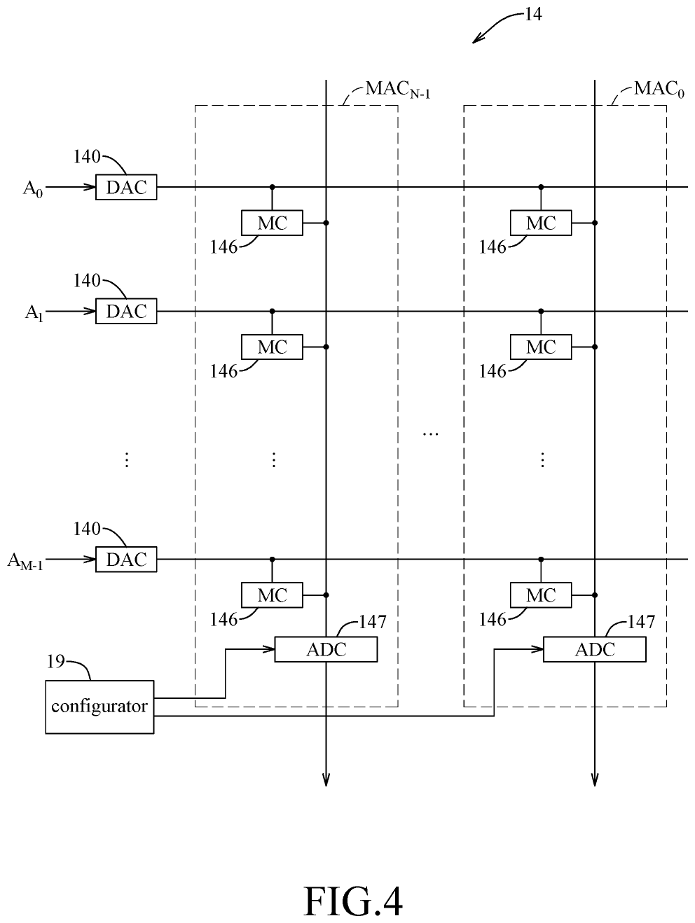

FIG. 4 illustrates a second exemplary implementation of the computing circuit 14. Referring to FIGS. 1 and 4, in the second exemplary implementation, the computing circuit 14 is implemented using analog circuits (e.g., compute-in-memory (CIM) circuits) (i.e., the computing circuit 14 is an in-memory computing circuit), and further includes a number (M) of digital-to-analog converters (DACs) 140, and each of the MAC slices (MAC₀−MAC_{N—1}) includes a number (M) of memory cells (MCs) 146 and an analog-to-digital converter (ADC) 147. Each of the DACs 140 receives a respective one of the multiplier inputs (A₀-A_{M-1}) of the feed-in multiplier vector, and converts the multiplier input (A₀/ . . . /A_{M-1}) thus received into an analog voltage. With respect to each of the MAC slices (MAC₀−MAC_{N-1}), the memory cells 146 are resistive, each have at least two resistance states (i.e., being able to store at least one bit of data), and respectively store the multiplicand segments (W_{0,0}—W_{M-1,0}, . . . , or W_{0,N-1}—W_{M-1,N-1}) of the multiplicand inputs (W₀-W_{M-1}) of the feed-in multiplicand vector that are received by the MAC slice (MAC₀/ . . . /MAC_{N—1}). The memory cells 146 are respectively coupled to the DACs 140 to respectively receive the analog voltages that are respectively generated by the DACs 140, and convert the analog voltages respectively into a plurality of currents that respectively flow through the memory cells 146. The ADC 147 is coupled to the memory cells 146 to receive a combination of the currents that respectively flow through the memory cells 146, is further coupled to the scaler 15 and the evaluator 18, and converts the combination of the currents into the inner product that is calculated by the MAC slice (MAC₀/ . . . /MAC_{N-1}) and that is to be received by the scaler 15 and the evaluator 18.

Optionally, in the second exemplary implementation of the computing circuit 14, the ADC 147 of each of the MAC slices (MAC₀−MAC_{N—1}) is further coupled to the configurator 19, and converts the combination of the currents into the inner product based on at least one reference voltage. Based on the evaluation output, the configurator 19 adjusts the at least one reference voltage used by the ADC 147 of each of some of the MAC slices (MAC₀−MAC_{N—1}) to downwardly shift an output range of said each of some of the MAC slice (MAC₀-MAC_{N-1}) by a predetermined value (i.e., an upper limit and a lower limit of the inner product obtained by said each of some of the MAC slice (MAC₀−MAC_{N—1}) are each decreased by the predetermined value), so as to mitigate impact of noise on the inner product calculated by said each of some of the MAC slice (MAC₀−MAC_{N—1}). The predetermined value is, for example, one or two. More specifically, by doing so, with respect to each of said some of the MAC slices (MAC₀−MAC_{N—1}), the MAC slice (MAC₀/ . . . /MAC_{N—1}) preserves the negative noises that occur during inner product calculation instead of cutting off the negative noises at the lower limit without the downward shift. Let us take an inner product of non-negative vectors for example. Since the vectors used by the MAC slice (MAC₀/ . . . /MAC_{N—1}) are non-negative, the lower limit of the inner product obtained by the MAC slice (MAC₀/ . . . /MAC_{N-1}) is zero. However, because of the existence of negative noises, sometimes the ADC 147 of the MAC slice (MAC₀/ . . . /MAC_{N—1}) may receive a negatively deviated current that falls within an input current range corresponding to an output code of minus one. Naive design cut off the output code of the ADC at zero. Instead, the ADC 147 of the MAC slice (MAC₀/ . . . /MAC_{N—1}) of the disclosure can output minus one. By doing so, the preserved negative noises can cancel out positive noises that occur at other inner products. In an example, the configurator 19 adjusts the at least one reference voltage used by the ADC 147 of one of the MAC slices (MAC₀−MAC_{N—1}) having the lowest accuracy among all of the MAC slices (MAC₀−MAC_{N—1}) in such a way that, for each output code of the ADC 147 of said one of the MAC slices (MAC₀−MAC_{N—1}), an input current range of the ADC 147 of said one of the MAC slices (MAC₀−MAC_{N—1}) corresponding to the output code after the adjustment, is identical to an input current range of the ADC 147 of said one of the MAC slices (MAC₀−MAC_{N—1}) corresponding to the output code minus the predetermined value before the adjustment. In a scenario where the inner product calculated by each of the MAC slices (MAC₀−MAC_{N—1}) is eight bits wide, where the predetermined value is one, and where the multiplier inputs (A₀-A_{M-1}) and the multiplicand segments (W_{0,0}—W_{M-1,0}, . . . , or W_{0,N-1}—W_{M-1,N-1}) of the multiplicand inputs (W₀-W_{M-1}) received by each of the MAC slices (MAC₀−MAC_{N—1}) are all non-negative integers, the output range of the MAC slice (MAC₀/ . . . /MAC_{N—1}) having the lowest accuracy is originally [0, 255], and will become [−1, 254] after being downwardly shifted. In another example, the configurator 19 adjusts the reference voltages used by the ADCs 147 of two of the MAC slices (MAC₀−MAC_{N—1}) having the lowest and second lowest accuracies among all of the MAC slices (MAC₀−MAC_{N—1}). It should be noted that, in other examples, the configurator 19 may adjust the reference voltages used by the ADCs 147 of three or more of the MAC slices (MAC₀−MAC_{N—1}) having the three or more lowest accuracies among all of the MAC slices (MAC₀−MAC_{N—1}). Alternatively, the ADCs 147 of the MAC slices (MAC₀−MAC_{N-1}) are not coupled to the configurator 19, and the reference voltages used by the ADCs 147 of the MAC slices (MAC₀−MAC_{N-1}) are properly selected in a design phase of the bit-serial computing device 1 such that the output range of each of the MAC slices (MAC₀−MAC_{N—1}) is [−1, 254].

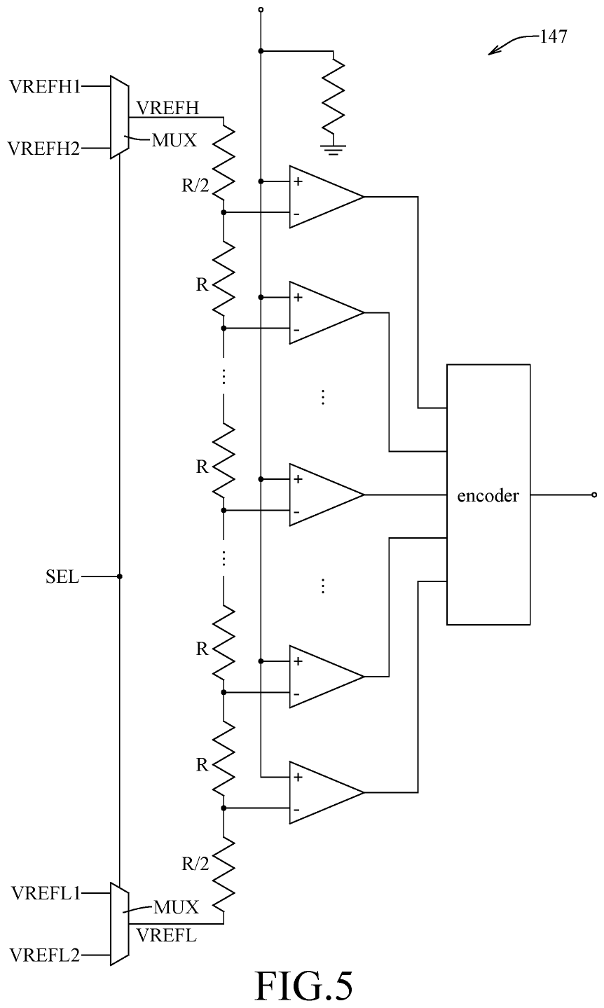

FIG. 5 illustrates an example of the ADC 147 of each of the MAC slices (MAC₀−MAC_{N—1}) of the second exemplary implementation of the computing circuit 14. Referring to FIGS. 1, 4 and 5, in the example as shown in FIG. 5, the ADC 147 is a flash ADC, and performs analog-to-digital conversion based on two reference voltages (VREHF, VREFL). The ADC 147 receives a selection signal (SEL) from the configurator 19, outputs one of two voltages (VREFH1, VREFH2) as the reference voltage (VREFH) based on the selection signal (SEL), and outputs one of two voltages (VREFL1, VREFL2) as the reference voltage (VREFL) based on the selection signal (SEL), where the voltage (VREFH1) is greater than the voltage (VREFH2) in magnitude, the voltage (VREFH2) is greater than the voltage (VREFL1) in magnitude, and the voltage (VREFL1) is greater than the voltage (VREFL2) in magnitude. Initially, the configurator 19 generates the selection signal (SEL) corresponding to that of the ADC 147 which outputs the voltage (VREFH1) as the reference voltage (VREFH) and outputs the voltage (VREFL1) as the reference voltage (VREFL). Thereafter, when necessary, the configurator 19 generates the selection signal (SEL) corresponding to that of the ADC 147 which outputs the voltage (VREFH2) as the reference voltage (VREFH) and outputs the voltage (VREFL2) as the reference voltage (VREFL), so as to downwardly shift the output range of the MAC slice (MAC₀/ . . . /MAC_{N—1}) including the ADC 147.

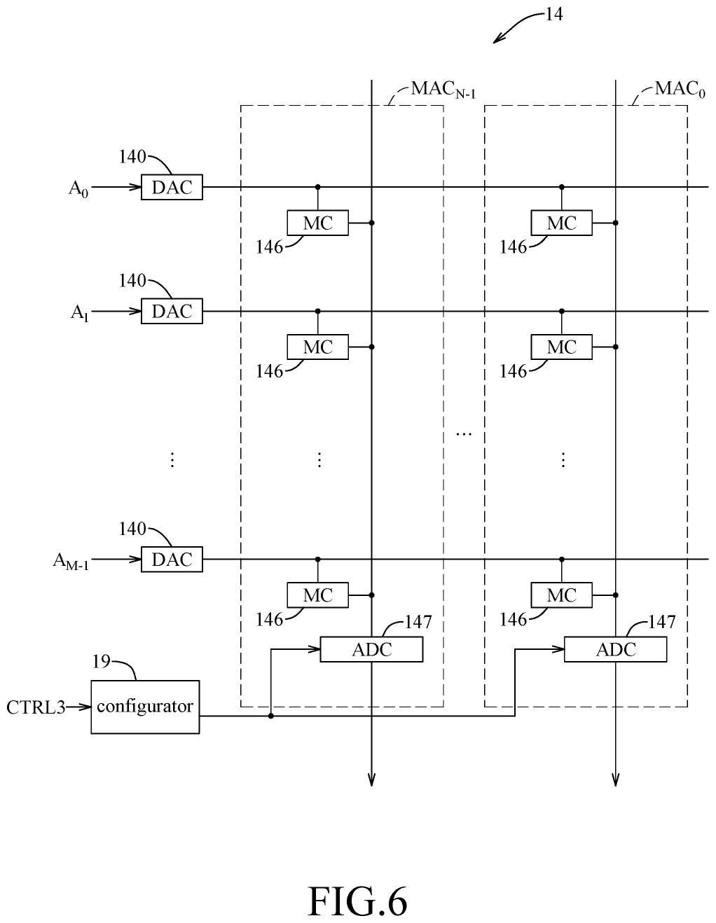

Referring to FIGS. 1 and 6, the second exemplary implementation of the computing circuit 14 may be controlled by the configurator 19 in another way. That is, the configurator 19 further receives a control signal (CTRL3) that indicates whether the output ranges of the MAC slices (MAC₀−MAC_{N—1}) should be downwardly shifted, and adjusts the reference voltages used by the ADCs 147 of the MAC slices (MAC₀−MAC_{N-1}) when the third control signal (CTRL3) indicates that the output ranges of the MAC slices (MAC₀−MAC_{N—1}) should be downwardly shifted.

It should be noted that, in other implementations of the computing circuit 14, each of the DACs 140 may convert the multiplier input (A₀/ . . . /A_{M-1}) of the feed-in multiplier vector received thereby into an analog current or a time interval, instead of the analog voltage; and with respect to each of the MAC slices (MAC₀-MAC_{N—1}), the memory cells 146 may not be resistive, and may convert the outputs of the DACs 140 respectively into a plurality of voltage or a plurality of time intervals, instead of the currents, and the ADC 147 may convert a combination of the outputs of the memory cells 146 into the inner product calculated by the MAC slice (MAC₀/ . . . /MAC_{N—1}). For instance, the memory cells 146 can be based on SRAM cells.

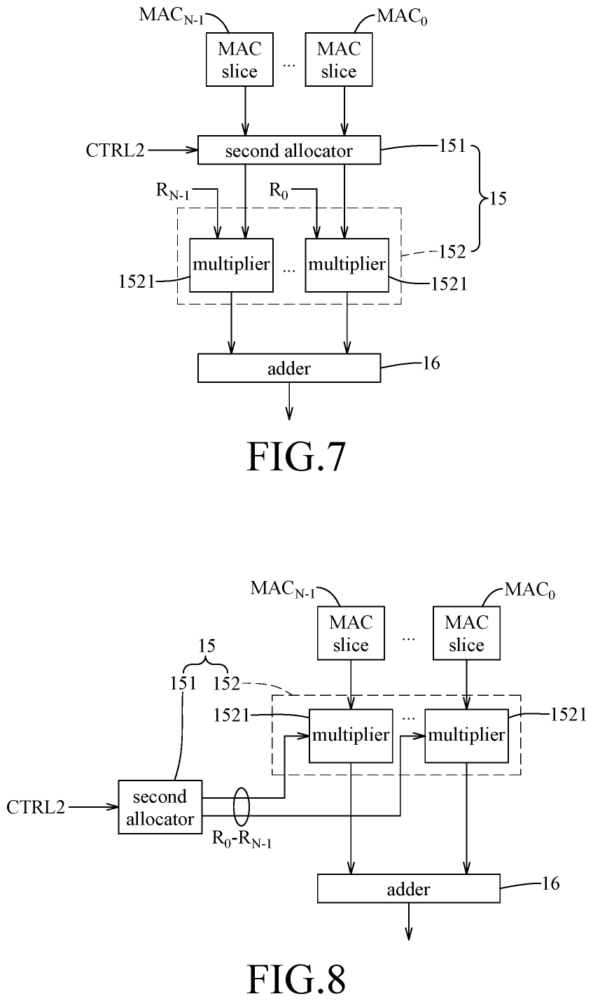

FIG. 7 illustrates a first exemplary implementation of the scaler 15. Referring to FIGS. 1 and 7, in the first exemplary implementation, the scaler 15 includes a second allocator 151 and a multiplier circuit 152. The second allocator 151 is coupled to the MAC slices (MAC₀−MAC_{N—1}) to receive the inner products that are respectively calculated by the MAC slices (MAC₀−MAC_{N—1}), and is further coupled to the configurator 19 to receive the control signal (CTRL2). The multiplier circuit 152 includes a number (N) of multipliers 1521 that are coupled to the second allocator 151 and the adder 16 and that respectively correspond to the weighting ratios (R₀-R_{N-1}) respectively representing the significances. With respect to each of the MAC slices (MAC₀−MAC_{N—1}), the second allocator 151 outputs the inner product that is calculated by the MAC slice (MAC₀/ . . . /MAC_{N—1}) for receipt by the multiplier 1521 that corresponds to the weighting ratio (R₀/ . . . /R_{N-1}) representing the significance corresponding to the MAC slice (MAC₀/ . . . /MAC_{N—1}) based on the control signal (CTRL2). Each of the multipliers 1521 multiplies the inner product that is received from the second allocator 151 by the weighting ratio (R₀/ . . . /R_{N-1}) that corresponds to the multiplier 1521, so as to obtain the scaled inner product that corresponds to the MAC slice (MAC₀/ . . . /MAC_{N—1}) calculating the inner product received from the second allocator 151 and that is to be received by the adder 16. The second allocator 151 may be implemented using a number (N²) of switches that are arranged in an N×N crossbar configuration.

FIG. 8 illustrates a second exemplary implementation of the scaler 15. Referring to FIGS. 1 and 8, in the second exemplary implementation, the scaler 15 includes a second allocator 151 and a multiplier circuit 152. The second allocator 151 stores the weighting ratios (R₀-R_{N-1}) that respectively represent the significances, and is coupled to the configurator 19 to receive the control signal (CTRL2). The multiplier circuit 152 includes a number (N) of multipliers (1521) that are respectively coupled to the MAC slices (MAC₀−MAC_{N—1}) to respectively receive the inner products respectively calculated by the MAC slices (MAC₀−MAC_{N—1}), and that are further coupled to the second allocator 151 and the adder 16. With respect to each of the MAC slices (MAC₀−MAC_{N—1}), the second allocator 151 outputs the weighting ratio (R₀/ . . . /R_{N-1}) that represents the significance corresponding to the MAC slice (MAC₀/ . . . /MAC_{N—1}) for receipt by the multiplier 1521 that is coupled to the MAC slice (MAC₀/ . . . /MAC_{N—1}) based on the control signal (CTRL2). Each of the multipliers 1521 multiplies the inner product that is received thereby by the weighting ratio (R₀/ . . . /R_{N-1}) that is received thereby, so as to obtain the scaled inner product that corresponds to the MAC slice (MAC₀/ . . . /MAC_{N—1}) coupled to the multiplier 1521 and that is to be received by the adder 16.

In view of the above, in this embodiment, by virtue of causing the MAC slice (MAC₀/ . . . /MAC_{N—1}) that has the highest accuracy to calculate the inner product of the feed-in multiplier vector and the vector that is constituted by the multiplicand segments (W_{0,N-1}—W_{M-1,N-1}) of the multiplicand inputs (W₀-W_{M-1}) of the feed-in multiplicand vector having the largest one of the significances, or by virtue of causing the MAC slice (MAC₀/ . . . /MAC_{N—1}) that has the lowest accuracy to calculate the inner product of the feed-in multiplier vector and the vector that is constituted by the multiplicand segments (W_{0,0}—W_{M-1,0}) of the multiplicand inputs (W₀-W_{M-1}) of the feed-in multiplicand vector having the smallest one of the significances, the output accuracy of the bit-serial computing device can be enhanced. Moreover, in the second exemplary implementation of the computing circuit 14, by virtue of downwardly shifting the output range of at least one of the MAC slices (MAC₀−MAC_{N—1}), the impact of the noise on the inner product calculated by the at least one of the MAC slices (MAC₀−MAC_{N—1}) can be mitigated. In addition, by virtue of the test method calculating and accumulating the absolute deviation for each of the MAC slices (MAC₀−MAC_{N—1}), the relative relationship of the accuracies of the MAC slices (MAC₀−MAC_{N—1}) can be determined.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A bit-serial computing device comprising:
a computing circuit receiving a feed-in multiplier vector and a feed-in multiplicand vector, and including a number (N) of multiply-and-accumulate (MAC) slices, where N≥2, the feed-in multiplier vector containing a number (M) of multiplier inputs, where M≥2, the feed-in multiplicand vector containing a number (M) of multiplicand inputs, each of which contains a number (N) of multiplicand segments that have different significances, the significances respectively corresponding to said MAC slices, correspondence between the significances and said MAC slices being variable;
each of said MAC slices calculating an inner product of the feed-in multiplier vector and a vector that is constituted by the multiplicand segments of the multiplicand inputs of the feed-in multiplicand vector having the significance corresponding to said MAC slice; and
a scaler coupled to said MAC slices to receive the inner products that are respectively calculated by said MAC slices, and further receiving a first control signal;
with respect to each of said MAC slices, said scaler multiplying the inner product that is calculated by said MAC slice by a weighting ratio that represents the significance corresponding to said MAC slice based on the first control signal, so as to obtain a scaled inner product that corresponds to said MAC slice.

2. The bit-serial computing device as claimed in claim 1, operable in a normal mode and a test mode, and further comprising:
a first multiplexer coupled to said computing circuit, receiving a normal multiplier vector, a test multiplier vector and a mode signal, outputting the normal multiplier vector as the feed-in multiplier vector to be received by said computing circuit when the mode signal indicates that said bit-serial computing device operates in the normal mode, and outputting the test multiplier vector as the feed-in multiplier vector to be received by said computing circuit when the mode signal indicates that said bit-serial computing device operates in the test mode.

3. The bit-serial computing device as claimed in claim 1, further comprising:
a first allocator coupled to said MAC slices, and receiving the feed-in multiplicand vector and a second control signal that indicates the correspondence between the significances and said MAC slices;
with respect to each of the significances, said first allocator outputting the multiplicand segments of the multiplicand inputs of the feed-in multiplicand vector that have the significance for receipt by said MAC slice that corresponds to the significance based on the second control signal.

4. The bit-serial computing device as claimed in claim 3, operable in a normal mode and a test mode, and further comprising:
a second multiplexer coupled to said first allocator, receiving a normal multiplicand vector, a test multiplicand vector and a mode signal, outputting the normal multiplicand vector as the feed-in multiplicand vector to be received by said first allocator when the mode signal indicates that said bit-serial computing device operates in the normal mode, and outputting the test multiplicand vector as the feed-in multiplicand vector to be received by said first allocator when the mode signal indicates that said bit-serial computing device operates in the test mode.

5. The bit-serial computing device as claimed in claim 1, further comprising:
an evaluator coupled to said MAC slices to receive the inner products that are respectively calculated by said MAC slices, and generating an evaluation output that indicates a relative relationship of accuracies of said MAC slices based on the inner products; and
a configurator coupled to said evaluator to receive the evaluation output, further coupled to said first allocator and said scaler, and generating the first control signal to be received by said scaler based on the evaluation output.

6. The bit-serial computing device as claimed in claim 5, wherein said configurator generates the first control signal corresponding to that of said scaler which multiplies the inner product calculated by one of said MAC slices having the highest accuracy among all of said MAC slices by the weighting ratio representing a largest one of the significances.

7. The bit-serial computing device as claimed in claim 5, wherein said configurator generates the second control signal corresponding to that of said first allocator which outputs the multiplicand segments of the multiplicand inputs of the feed-in multiplicand vector having a smallest one of the significances to one of said MAC slices having the lowest accuracy among all of said MAC slices, and generates the first control signal corresponding to that of said scaler which multiplies the inner product calculated by said one of said MAC slices by the weighting ratio representing the smallest one of the significances.

8. The bit-serial computing device as claimed in claim 1, wherein said scaler includes:
a second allocator coupled to said MAC slices to receive the inner products that are respectively calculated by said MAC slices, and further receiving the first control signal; and
a multiplier circuit including a number (N) of multipliers that are coupled to said second allocator and that respectively correspond to the weighting ratios respectively representing the significances;
with respect to each of said MAC slices, said second allocator outputting the inner product that is calculated by said MAC slice for receipt by said multiplier that corresponds to the weighting ratio representing the significance corresponding to said MAC slice based on the first control signal;
each of said multipliers multiplying the inner product that is received from said second allocator by the weighting ratio that corresponds to said multiplier, so as to obtain the scaled inner product that corresponds to said MAC slice calculating the inner product received from said second allocator.

9. The bit-serial computing device as claimed in claim 1, wherein said scaler includes:
a second allocator storing the weighting ratios that respectively represent the significances, and receiving the first control signal; and
a multiplier circuit including a number (N) of multipliers that are respectively coupled to said MAC slices to respectively receive the inner products respectively calculated by said MAC slices, and that are further coupled to said second allocator;
with respect to each of said MAC slices, said second allocator outputting the weighting ratio that represents the significance corresponding to said MAC slice for receipt by said multiplier that is coupled to said MAC slice based on the first control signal;
each of said multipliers multiplying the inner product that is received thereby by the weighting ratio that is received thereby, so as to obtain the scaled inner product that corresponds to said MAC slice coupled to said multiplier.

10. The bit-serial computing device as claimed in claim 1, wherein each of said MAC slices includes:
a number (M) of registers respectively storing the multiplicand segments of the multiplicand inputs of the feed-in multiplicand vector that have the significance corresponding to said MAC slice;
a number (M) of multipliers, each of which is coupled to a respective one of said registers to receive the multiplicand segment stored in the respective one of said registers, further receives a respective one of the multiplier inputs of the feed-in multiplier vector, and calculates a product of the multiplicand segment thus received and the multiplier input thus received; and
a summator coupled to said multipliers to receive the products that are respectively calculated by said multipliers, further coupled to said scaler, and calculating a sum of the products to obtain the inner product that is calculated by said MAC slice and that is to be received by said scaler.

11. The bit-serial computing device as claimed in claim 1, wherein said computing circuit is an in-memory computing circuit.

12. The bit-serial computing device as claimed in claim 11, wherein:
said computing circuit further includes a number (M) of digital-to-analog converters (DACs);
each of said DACs receives a respective one of the multiplier inputs of the feed-in multiplier vector, and converts the multiplier input thus received into an analog voltage;
each of said MAC slices includes a number (M) of memory cells and an analog-to-digital converter (ADC); and
with respect to each of said MAC slices,
said memory cells are resistive, are respectively coupled to said DACs to respectively receive the analog voltages that are respectively generated by said DACs, and respectively store the multiplicand segments of the multiplicand inputs of the feed-in multiplicand vector that have the significance corresponding to said MAC slice, and
said ADC is coupled to said memory cells to receive a combination of currents that respectively flow through said memory cells, is further coupled to said scaler, and converts the combination of the currents into the inner product that is calculated by said MAC slice and that is to be received by said scaler.

13. The bit-serial computing device as claimed in claim 12, further comprising:
an evaluator coupled to said ADCs of said MAC slices to receive the inner products that are respectively calculated by said MAC slices, and generating an evaluation output that indicates a relative relationship of accuracies of said MAC slices based on the inner products; and
a configurator coupled to said evaluator to receive the evaluation output, and further coupled to said ADCs of said MAC slices;
said ADC of each of said MAC slices converting the combination of the currents into the inner product based on at least one reference voltage;
based on the evaluation output, said configurator adjusting the at least one reference voltage used by said ADC of one of said MAC slices having the lowest accuracy among all of said MAC slices in such a way that, for each output code of said ADC of said one of said MAC slices, an input current range of said ADC of said one of said MAC slices corresponding to the output code after the adjustment is identical to an input current range of said ADC of said one of said MAC slices corresponding to the output code minus a predetermined value before the adjustment.

14. The bit-serial computing device as claimed in claim 13, wherein the predetermined value is one or two.

15. The bit-serial computing device as claimed in claim 13, wherein, based on the evaluation output, said configurator further adjusts the at least one reference voltage used by said ADC of another one of said MAC slices having the second lowest accuracy among all of said MAC slices in such a way that, for each output code of said ADC of said another one of said MAC slices, an input current range of said ADC of said another one of said MAC slices corresponding to the output code after the adjustment is identical to an input current range of said ADC of said another one of said MAC slices corresponding to the output code minus the predetermined value before the adjustment.

16. The bit-serial computing device as claimed in claim 12, further comprising:
a configurator coupled to said ADCs of said MAC slices, and receiving a third control signal;
said ADC of each of said MAC slices converting the combination of the currents into the inner product based on at least one reference voltage;
when the third control signal indicates that output ranges of said MAC slices should be downwardly shifted, said configurator, with respect to each of said MAC slices, adjusting the at least one reference voltage used by said ADC of said MAC slice in such a way that, for each output code of said ADC of said MAC slice, an input current range of said ADC of said MAC slice corresponding to the output code after the adjustment is identical to an input current range of said ADC of said MAC slice corresponding to the output code minus a predetermined value before the adjustment.

17. The bit-serial computing device as claimed in claim 12, wherein an output range of at least one of said MAC slices has a lower limit of minus one.

18. The bit-serial computing device as claimed in claim 1, further comprising:
an adder coupled to said scaler to receive the scaled inner products that respectively correspond to said MAC slices, and adding the scaled inner products together to obtain an inner product of the feed-in multiplier vector and the feed-in multiplicand vector.

19. A test method for evaluating a bit-serial computing device according to claim 1, said test method comprising steps of:
(A) generating at least one first test multiplier vector and at least one second test multiplier vector, where a first linear function of the at least one first test multiplier vector is equal to a second linear function of the at least one second test multiplier vector;
(B) sequentially providing the first and second test multiplier vectors to the computing circuit as the feed-in multiplier vector, so that each of the MAC slices sequentially obtains at least one first inner product that corresponds to the at least one first test multiplier vector and at least one second inner product that corresponds to the at least one second test multiplier vector as the inner product calculated thereby;
(C) with respect to each of the MAC slices, calculating an absolute deviation that corresponds to the MAC slice, and that equals an absolute value of the first linear function of the at least one first inner product obtained by the MAC slice minus the second linear function of the at least one second inner product obtained by the MAC slice;
(D) repeating step (B) and step (C), and with respect to each of the MAC slices, accumulating the absolute deviation that corresponds to the MAC slice, so as to obtain an accumulated deviation that corresponds to the MAC slice; and
(E) generating an evaluation output based on the accumulated deviations that respectively correspond to the MAC slices, where the evaluation output indicates a relative relationship of accuracies of the MAC slices, and the accuracy of one of the MAC slices is determined to be higher than the accuracy of another one of the MAC slices when the accumulated deviation that corresponds to said one of the MAC slices is smaller than the accumulated deviation that corresponds to said another one of the MAC slices.

20. The test method as claimed in claim 19, wherein step (D) further includes repeating step (A).

21. The test method as claimed in claim 19, wherein:
in step (A), further generating a test multiplicand vector; and
in step (B), further providing the test multiplicand vector to the computing circuit as the feed-in multiplicand vector.

22. The test method as claimed in claim 21, wherein step (D) further includes repeating step (A).

23. The test method as claimed in claim 19, wherein, in step (A), a plurality of the first test multiplier vectors are generated, and the first test multiplier vectors are different from each other.

24. The test method as claimed in claim 19, wherein, in step (A), a plurality of the first test multiplier vectors are generated, and at least two of the first test multiplier vectors are identical.

25. A bit-serial computing device comprising:
a computing circuit including a multiply-and-accumulate (MAC) slice that calculates an inner product of a feed-in multiplier vector and another vector;
a test pattern generator coupled to said computing circuit, and generating at least one first test multiplier vector and at least one second test multiplier vector, where a first linear function of the at least one first test multiplier vector is equal to a second linear function of the at least one second test multiplier vector;
said test pattern generator sequentially providing the first and second test multiplier vectors to said computing circuit as the feed-in multiplier vector, so that said MAC slice sequentially obtains at least one first inner product that corresponds to the at least one first test multiplier vector and at least one second inner product that corresponds to the at least one second test multiplier vector as the inner product calculated by said MAC slice; and
an evaluator coupled to said MAC slice to receive the at least one first inner product and the at least one second inner product, calculating an absolute deviation that equals an absolute value of the first linear function of the at least one first inner product minus the second linear function of the at least one second inner product; and increasing an accumulated deviation by the absolute deviation.
